(19) United States
(12) Patent Application Publication
(10) Pub. No.: US 2004/0262049 A1
(43) Pub. Date: Dec. 30, 2004

(54) Seat weight measuring device

(75) Inventors: Tomotoshi Senoh, Hikone-shi (JP); Tetsuo Yoshida, Utsunomiya-shi (JP)

Correspondence Address: FOLEY AND LARDNER, SUITE 500, 3000 K STREET NW, WASHINGTON, DC, 20007, US

(73) Assignee: TAKATA CORPORATION

(21) Appl. No.: 10/822,706

(22) Filed: Apr. 13, 2004

(30) Foreign Application Priority Data
Jun. 27, 2003 (JP) 2003-184649
Jan. 23, 2004 (JP) 2004-15710

(51) Int. Cl. G01G 19/52; B60R 21/32

(52) U.S. Cl. 177/144

(57) ABSTRACT

A device for measuring a weight of a seat, including the weight of an occupant sitting on the seat. The device includes a resilient member supported by at least one support point;

a load sensor supported by a sensor support. The load sensor is in communication with the resilient member to receive the weight of the seat; the weight of the seat is applied between the at least one support point and the sensor point.

### BACKGROUND

The present invention relates to seat weight measuring devices, which are mounted to a vehicle seat and measure seat weight including the weight of an occupant sitting on a vehicle seat.

In an automobile, a seat belt device and an airbag device are provided as equipment for ensuring safety of an occupant. Recently, for the purpose of improving the performance of seat belts and airbags, efforts to control the operation of those safety devices have been made in a manner matched with the weight and posture of the occupant. For example, the amount of gas for expanding an airbag and the expansion speed of the airbag are adjusted or pretension of a seat belt is adjusted in match with the weight and posture of the occupant. Such an adjustment requires it to know the weight of the occupant sitting on a seat, and to know the position where the center of weight of the occupant locates on the seat.

To be adapted for those requirements, a seat weight measuring device is proposed which can accurately measure the seat weight at the lowest possible cost.

FIG. 4 is a side view conceptually showing the construction of a seat weight measuring device. FIG. 5 partially shows a front portion of the seat weight measuring device. FIG. 5(A) is an exploded perspective view, and FIG. 5(B) is a front sectional view of a pin bracket section. FIG. 6 partially shows the front portion of the seat weight measuring device shown in FIG. 5. FIG. 6(A) is a plan view, FIG. 6(B) is a sectional view as viewed in the lengthwise direction, FIG. 6(C) is a sectional view taken along the line C-C in FIG. 6(B), and FIG. 6(D) is a sectional view taken along the line D-D in FIG. 6(B). Note that the right-and-left direction on the drawing sheets of FIGS. 4, 6(A) and 6(B) corresponds to the back-and-forth direction of a vehicle, and that since the seat weight measuring device is substantially symmetrical in the back-and-forth direction, one half of the device is omitted from the drawings.

As shown in FIG. 4, the seat weight measuring device 9 comprises a coupling mechanism 15 for coupling a seat 3 (including a seat frame and seat rails) to a seat mounting portion 13 of a vehicle body and for bearing seat weight, and a transmitting mechanism 16 for transmitting the seat weight acting on the coupling mechanism 15 to load sensors 54 of a load meter 50.

The coupling mechanism 15 comprises a bearing member (pin bracket) 25, an arm (Z-arm) 23, a base pin (corresponding to a fulcrum support in the present invention) 31, a base 21, etc. The bearing member 25 is a disposed in each of the front, rear, left and right sides of the seat 3 for transmitting the weight of the seat itself and the weight of an occupant sitting on the seat to the arm (corresponding to a resilient member in the present invention) 23. The arm 3 is rotatable about the base pin 31. The base pin 31 is coupled to the seat mounting portion 13 of the vehicle body through the base 21.

The load meter 50 is formed by attaching strain gauges 54, serving as the load sensors, onto an upper flat surface of a sensor plate 51. Support points or fulcrums (corresponding to a sensor support in the present invention) 41b, 42b are formed on the underside of the sensor plate 51 at its left end side. A vertical load is transmitted from an acting part 23j of the arm 23 to the sensor plate 51 through these support points. The transmitted load is measured by the strain gauges 54 on the sensor plate 51.

How a load is transmitted in the seat weight measuring device 9 will be described below. A load W of the seat 3 is transmitted from the bearing member 25 to the arm 23. The load W includes a vertical component Wv and a horizontal component Wh. The vertical component Wv includes the weight of the seat 3 itself and a part of the weight of an occupant. Of these weights, the weight of the occupant transmitted from one bearing member 25 to the arm 23 differs depending on the weight and posture of the occupant, the acceleration of the vehicle, and so on. On the other hand, the horizontal component Wh of the load W varies primarily depending on the acceleration of the vehicle and forces applied from the occupant's legs stretched against a vehicle floor.

Herein, the distance (span) between the position (coupling point) where the bearing member 25 acts upon the arm 23 and the center axis of the base pin 31 (fulcrum of rotation) is S1, and the distance (span) between the center axis of the base pin 31 and the acting part 23j of the load upon the load meter 50 is S2. Accordingly, a vertical component Wv2 transmitted from the arm acting part 23j to the sensor plate 51 is given as follows: Wv2=Wv×S1/S2. A vertical component Wv1 supported by the base pin 31 is given as follows:

Wv1=Wv+Wv2=Wv(1+(S1/S2)).

On the other hand, the horizontal component Wh of W is borne by the base pin 31 and is hardly transmitted to the sensor plate 51. Stated another way, the transmitting mechanism 16 of the seat weight measuring device 9 has a characteristic of selectively transmitting, to the load meter 50, the vertical component of the load W applied from the seat 3 to the coupling mechanism 15.

As shown in FIGS. 5(A) and 5(B) and FIGS. 6(A) and 6(B), the known seat weight measuring device 9 is constructed by using the elongate base 21 as a base member. The base 21 is extended long in the back-and-forth direction when the seat weight measuring device 9 is mounted to the vehicle body. As shown in FIGS. 6(C) and 6(D), the base 21 is made of a stamped steel plate having a substantially C-shaped cross-section opened upward, and comprises a bottom plate 21c and side plates 21a, 21a′ bent 90° at left and right ends of the bottom plate 21c so as to rise upward from them.

Each of the base side plates 21a, 21a′ has pin holes 21e, 21g opened at two positions spaced from each other in the back-and-forth (longitudinal) direction. The holes 21e, 21g are opened it the right and left side plates 21a, 21a′ in an opposite relation. The hole 21e nearer to the longitudinal end of the base 21 is opened at a location away from the longitudinal end toward the center of the base 21 by a distance that is substantially ⅛ of an overall length of the base 21. As shown in FIG. 5(A), the holes 21e are each an elongate hole extending longer in the vertical direction. A shaft portion of a bracket pin (corresponding to a force acting point in the present invention) 27 is inserted in the elongate holes 21e. A retainer 33 is attached to an end of the bracket pin 27 lying in the right-and-left direction. The retainer 33 serves to prevent the bracket pin 27 from slipping off from the elongate holes 21e.

Gaps are left between the bracket pin 27 and inner edges, i.e., upper, lower, left and right edges, of each elongate hole 21e so that the bracket pin 27 is usually kept out of contact with the inner edges of the elongate hole 21e. However, when an excessive load is applied to the seat weight measuring device 9 (specifically a pin bracket 25 section), the bracket pin 27 descends and strikes against the lower edge of the elongate hole 21e to avoid the excessive load from being transmitted to the load sensor 50 (sensor plate 51). In other words, the bracket pin 27 and the elongate holes 21e constitute a part of a mechanism for restricting an upper limit of the load applied to the sensor plate 51. Additionally, a main role of the bracket pin 27 is to transmit the seat weight imposed on the pin bracket 25 to the Z-arm 23.

The pin holes 21g are each opened at a location slightly closer to the center of the base 21 than the elongate hole 21e (by a distance substantially 1/10 of the overall length of the base 21). A base pin 31 penetrates the pin holes 21g. The base pin 31 is laid to bridge between the right and left base side plates 21a, 21a′. A retainer 33 is a attached to an end of the base pin 31 lying in the right-and-left direction such that the base pin 31 is fixed to the base 21. Incidentally, the base pin 31 serves as an axis about which the Z-arm 23 rotates.

The Z-arm 23 is disposed inside the base 21. In a plan view of the Z-arm 23, a portion closer to the center of the base 21 is bifurcated into right and left legs (bifurcated portion 23h), and a portion closer to the longitudinal end of the base 21 has a rectangular shape. Side plates 23a, 23a′ are formed by bending 90° upward right and left end portions of a half of the Z-arm 23, which is located closer to the longitudinal end of the base 21. The bifurcated portion 23h is in the form of a simple flat plate. The side plates 23a, 23a′ are positioned inside the side plates 21a, 21a′ of the base 21 to extend along them. A gap is left between both the side plates 23a (or 23a′) and 21a (or 21a′).

Two pin holes 23c, 23e are opened in each of the Z-arm side plates 23a, 23a′. The bracket pin 27 penetrates the pin holes 23c positioned closer to the longitudinal end side. The bracket pin 27 hardly slides relative to each of the pin holes 23c. The base pin 31 penetrates the pin holes 23e positioned closer to the center side. The base pin 31 serves as the center for rotation of the Z-arm 23, and therefore the base pin 31 slides relative to the pin holes 23e corresponding to the rotation of the Z-arm 23. A holed disk-shaped spacer 35 is fitted over an outer periphery of the base pin 31 at a position between the base side plate 21a (or 21a′) and the Z-arm side plate 23a (or 23a′).

The bifurcated portion 23h of the Z-arm 23 has a length substantially equal to a half of the overall length of the Z-arm 23. The bifurcated portion 23h is branched into the right and left legs, which are extended toward the center of the base in the longitudinal direction and have a width narrowing toward the center side. Acting parts 23j formed by fore ends of the Z-arm bifurcated portion 23h of the Z-arm 23 are interposed between wing portions 41a, 42a of upper and lower half arms 41, 42.

When a load is applied to the pin bracket 25, the Z-arm 23 is slightly rotated (about 5° at maximum) and the acting parts 23j transmit the load to the sensor plate 51 through the upper and lower half arms 41, 42. The strain gauges are attached onto the sensor plate 51 to measure the applied load. The pin bracket 25 has, as shown in FIG. 6(C), a substantially C-shaped cross-section opened downward. A length of the pin bracket 25 in the back-and-forth direction is not so large, i.e., about 1/20 of the overall length of the base 21. The pin bracket 25 has a flat upper surface 25a on which a seat rail 7 of the seat 3 is laid. The pin bracket 25 and the seat rail 7 are firmly coupled to each other by fastening bolts or the likes. Further, the sensor plate 51 is fixed to a column 63 provided in a central area of the base bottom plate 21c by a nut 68 and a screw 69.

Right and left side plates 25b of the pin bracket 25 are vertically extended downward from the right and left sides of the pin bracket 25, and their lower ends are bent to project inward. The side plates 25b are disposed inside the Z-arm side plates 23a, 23a′ with plays left between them. Pin holes 25c are opened respectively in the side plates 25b. The bracket pin 27 penetrates the pin holes 25c. Each of the pin holes 25c has a size larger than the diameter of the bracket pin 27. Gaps left between the pin holes 25c and the bracket pin 27 serve to absorb dimensional errors and accidental deformations of the seat and the vehicle body.

A spring leaf 29 is interposed between the right and left side plates 25b of the pin bracket 25 and the right and left Z-arm side plates 23a, 23a′. The spring leaf 29 has spring washer-like portions having holes, which are fitted over an outer periphery of the bracket pin 27 with gaps left between them. The spring leaf 29 constitutes a centering mechanism for biasing the pin bracket 25 so as to centrally position. Such a centering mechanism serves to locate the pin bracket 25 as close as possible to the center of its slidable range.

In the seat weight measuring device 9 thus constructed, the seat rail 7 of the seat 3, the pin bracket 25, the Z-arm 23, the base 21, a seat bracket 11, etc. constitute a mechanism for coupling the seat and the vehicle body of each other.

In the known seat weight measuring device 9, however, the base pin 31 serving as the fulcrum for the arm 23 is positioned, as shown in FIG. 7(A), between the bracket pin 27, which serves as a force acting point applied with the seat weight and supports the one end side of the arm 23, and the support points 41b, 42b for the sensor plate 51, which serve as a force acting point and support the acting part 23j at the other end side of the arm 23. As shown in FIG. 7(B), therefore, when the seat load is applied to the bracket pin 27, the bracket pin 27 descends while the position of the support points 41b, 42b and the position of the base pin 31 are both kept not changed, thereby causing the arm 23 to resiliently deflect upward in its portion between the support points 41b, 42b and the base pin 31.

Stated another way, with a descent of the bracket pin 27, the seat rail 7 also descends while the arm 23 deflects upward as described above, whereby the seat rail 7 and the deflected portion of the arm 23 come closer to each other, thus resulting in a risk of interference between them. For that reason, it is required to maintain a sufficient spacing between the seat rail 7 and the arm 23.

To maintain the sufficient spacing, however, the height of the seat rail 7 relative to the arm 23 must be set so as to ensure a sufficient space between them, and the height of the seat weight measuring device 9 is necessarily increased

### SUMMARY OF THE INVENTION

An exemplary object of the present invention is to provide a seat weight measuring device that can be suppressed from increasing in height even when an arm for transmitting seat weight to a sensor deflects with the seat weight. According to an embodiment of the present invention, a seat weight measuring device is provided. The device includes a resilient member for transmitting, to a load sensor, seat weight including the weight of an occupant sitting on a vehicle seat, said resilient member is supported by a fulcrum support and a sensor support for said load sensor, the seat weight is applied to said resilient member, wherein a force acting point on said resilient member, to which the seat weight is applied, is set between said fulcrum support and said sensor support.

According to another exemplary embodiment of the present invention a seat weight measuring device is provided in which the height of the seat weight measuring device can be suppressed from increasing even when an arm for transmitting seat weight to a sensor deflects with the seat weight. The seat weight measuring device may include a resilient member for transmitting, to a load sensor, seat weight including the weight of an occupant sitting on a vehicle seat, the resilient member is supported by a fulcrum support and a sensor support for the load sensor, the seat weight is applied to the resilient member, wherein a force acting point on the resilient member, to which the seat weight is applied, is set between the fulcrum support and the sensor support.

According to the seat weight measuring device of an embodiment of the present invention, the device is constructed such that a deflected portion of a resilient member is caused to move away from a support member for a vehicle seat instead of coming closer to the support member for the vehicle seat. The support member for the vehicle seat and the deflected portion of the resilient member are hence prevented from interfering with each other.

Consequently, the spacing between the support member for the vehicle seat and the resilient member is not required to be set so large, and the height of the seat weight measuring device can be suppressed from increasing.

An exemplary embodiment of the present invention will be described below with reference to the drawings.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 partially and schematically shows one embodiment of a seat weight measuring device according to the present invention, in which FIG. 1(A) is an illustration showing a state of an arm before application of a seat load, and FIG. 1(B) is an illustration showing a state of the arm after application of the seat load.

FIG. 2 partially shows the front portion of one embodiment of the seat weight measuring device shown in FIG. 1, in which FIG. 2(A) is a plan view and FIG. 2(B) is a front view.

FIG. 3 partially shows the front portion of another embodiment of a seat weight measuring device according to the present invention, in which FIG. 3(A) is a plan view and FIG. 2(B) is a front view.

FIG. 4 is a side view conceptually showing the construction of a seat weight measuring device.

FIG. 5 partially shows a front portion of the seat weight measuring device in which FIG. 5(A) is an exploded perspective view, and FIG. 5(B) is a front sectional view of a pin bracket section.

FIG. 6 partially shows the front portion of the seat weight measuring device shown in FIG. 5, in which FIG. 6(A) is a plan view, FIG. 6(B) is a sectional view as viewed in the lengthwise direction, FIG. 6(C) is a sectional view taken along the line C-C in FIG. 6(B), and FIG. 6(D) is a sectional view taken along the line D-D in FIG. 6(B).

FIG. 7 partially and schematically shows a seat weight measuring device of the prior art in which FIG. 7(A) is an illustration showing a state of the arm before application of a seat load, and FIG. 7(B) is an illustration showing a state of the arm after application of the seat load.

### DETAILED DESCRIPTION

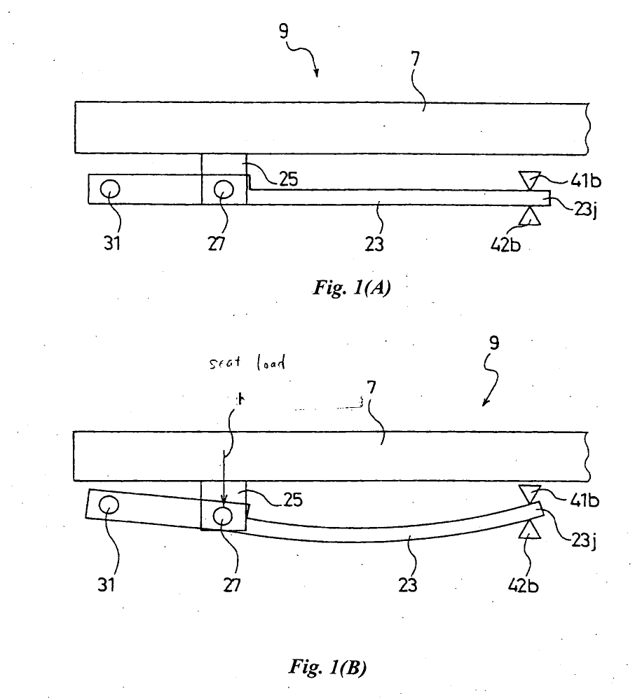

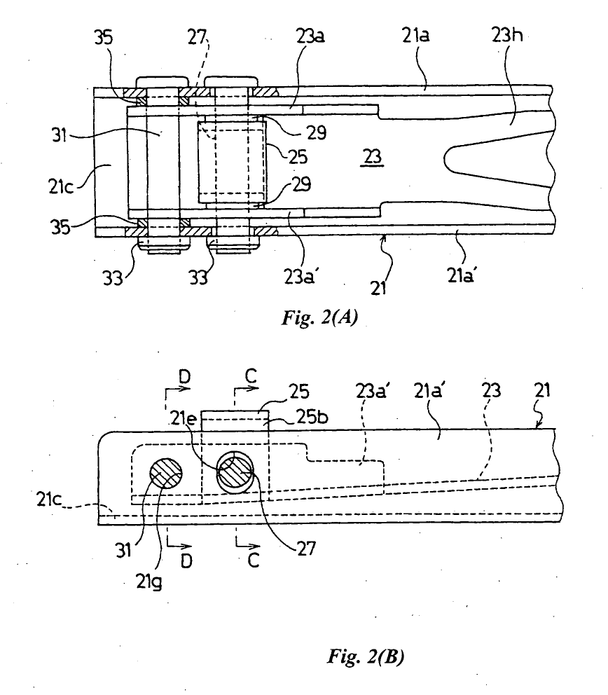

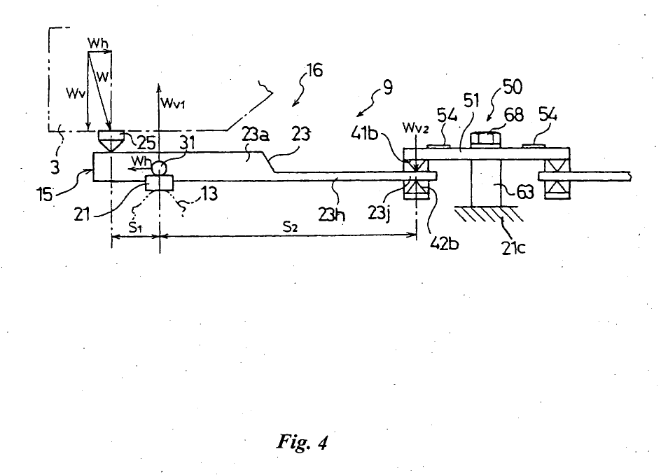

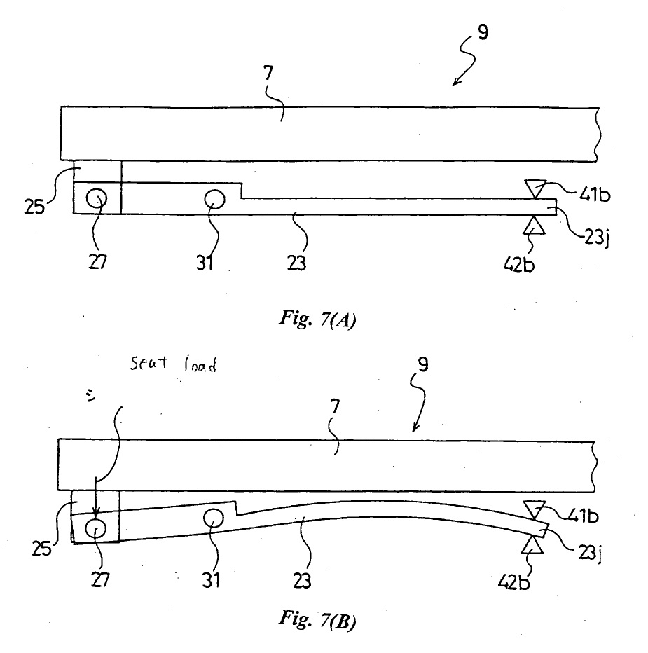

FIG. 1 partially and schematically shows one embodiment of a seat weight measuring device according to the present invention, in which FIG. 1(A) shows a state of an arm before application of a seat load, and FIG. 1(B) shows a state of the arm after application of the seat load, and FIG. 2 partially and specifically shows the front portion of one embodiment of the seat weight measuring device shown in FIG. 1, in which FIG. 2(A) is a plan view and FIG. 2(B) is a front view. Note that the same components as those of the above-described seat weight measuring device, shown in FIGS. 4 to 7, are denoted by the same symbols and a detailed description of those components is omitted here.

In a seat weight measuring device 9 of this embodiment, as shown in FIG. 1(A), and FIG. 2(B), one end portion of an arm 23 is supported by a base pin 31 serving as a fulcrum support for the arm 23. Also, between the base pin 31 and support points 41(B), 42(B) provided on a sensor plate 51, which supports an acting part 23j formed by the other end portion of the arm 23 and is a sensor support, a bracket pin 27 is positioned to serve as a force acting point, to which seat weight is applied, and to support the arm 23.

Other components of the seat weight measuring device 9 of this exemplary embodiment may be the same as those of the above -described seat weight measuring device, shown in FIGS. 4 to 7.

In the seat weight measuring device 9 of this exemplary embodiment, as shown in FIG. 1(B), when the seat load is applied to the bracket pin 27, the bracket pin 27 descends while the position of the support points 41(B), 42(B) and the position of the base pin 31 are both kept not changed, thereby causing the arm 23 to resiliently deflect downward in its portion between the support points 41(B), 42(B) and the base pin 31.

Stated another way, with a descent of the bracket pin 27, the seat rail 7 of the seat 3 also descends, but at this time the arm 23 deflects downward as described above. Therefore, the deflected portion of the arm 23 is moved away from the seat rail 7 instead of coming closer to the seat rail 7. The seat rail 7 and the deflected portion of the arm 23 are hence prevented from interfering with each other.

Accordingly, the spacing between the seat rail 7 and the arm 23 is not required to be set so large, and the height of the seat weight measuring device 9 can be suppressed from increasing.

The other operational and advantageous features of the seat weight measuring device 9 of this exemplary embodiment are the same as those of the above described seat weight measuring device, shown in FIGS. 4 to 7.

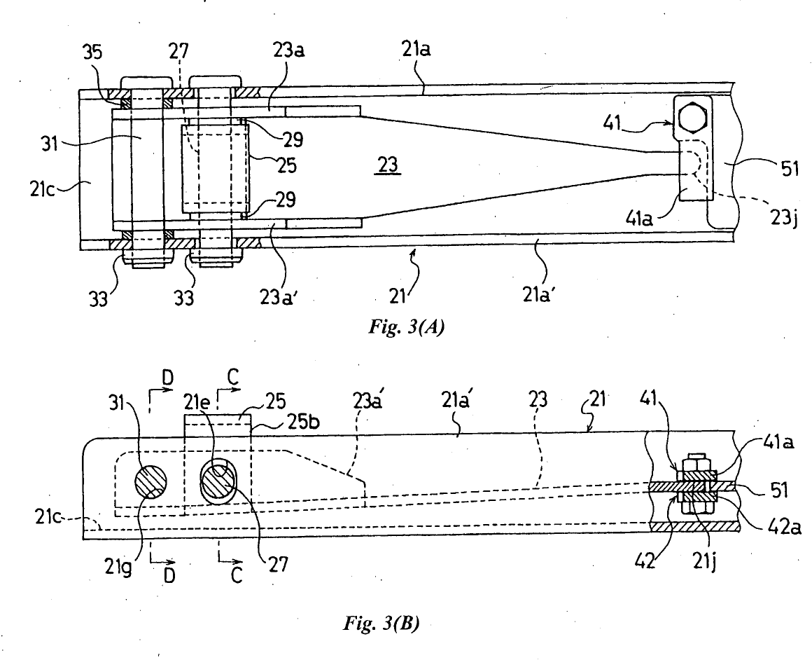

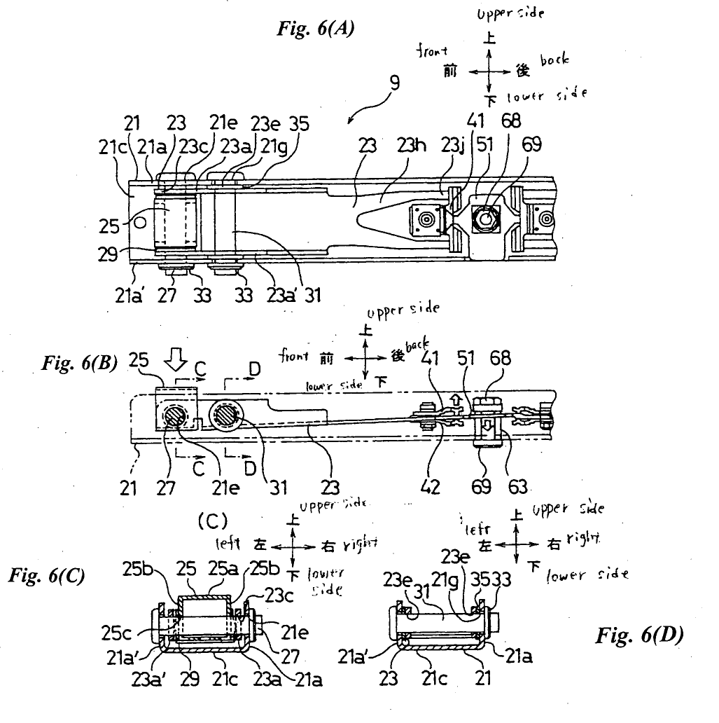

FIG. 3 partially shows the front portion of another embodiment of a seat weight measuring device according to the present invention, in which FIG. 3(A) is a plan view and FIG. 2(B) is a front view. Note that the same components as those of the known seat weight measuring device, shown in FIGS. 4 to 7, denoted by the same symbols and a detailed description of those components is omitted here. Also, a sectional view taken along the line C-C in FIG. 3 is the same sectional view as those of FIG. 6(C), and a sectional view taken along the line D-D in FIG. 3 is the same sectional view as those of FIG. 6(D).

In one embodiment shown in FIGS. 2(A) and 2(B), the same components as those of the above-described seat weight measuring device, shown in FIGS. 4 to 7, the bifurcated portion 23h is formed on the arm 23, and the arm 23 has two acting parts 23j. However, alternatively in the seat weight measuring device 9 of the embodiment as shown in FIGS. 3(A) and (B), the arm 23 does not have the bifurcated portion 23h and have a single acting part 23j at the tip of the arm 23. This single acting part 23j is positioned between the upper and lower half arms 41, 42 mounted on the sensor plate 51 respectively, and seat weight is transmitted from the arm 23 to the sensor plate 51 through the upper and lower half arms 41, 42.

The other components of the arm 23 are as known in the art, such as of the above-mentioned prior art embodiment. The arm 23 is rotatably supported by the side plates 21a, 21a′ of the base 21 through the base pin 31. Also, the bracket pin 27 passes through the side plates 23a, 23a′ of the arm 23 and passes through the side plates 21a, 21a′ of the base 21. Accordingly, the seat weight from the pin bracket 25 is transmitted to the arm 23 through the bracket pin 27, but is not transmitted to the base 21 through the bracket pin 27.

Also, the pin bracket of the present invention, unlike the pin bracket of the prior art is rotatably supported by the base pin 31 and transmits the seat weight to the bracket pin 27.

Other components of the seat weight measuring device 9 of this embodiment are the same as those of the above-described seat weight measuring device, shown in FIG. 2 and FIGS. 4 to 6.

Also, the state of the arm associated with the seat load in the seat weight measuring device of this embodiment is the same as those of FIGS. 1(A) and 1(B).

In the seat weight measuring device 9 of this embodiment, the seat weight transmitted to the arm 23 is transmitted to the sensor plate 51 through the single acting part 23j. As stated above, the arm 23 is not formed on the bifurcated portion and has the single acting part 23j. Thus, accuracy in manufacturing the arm 23 can be lower than those of the bifurcated portion. As a result, the arm 23 can be easily and inexpensively manufactured.

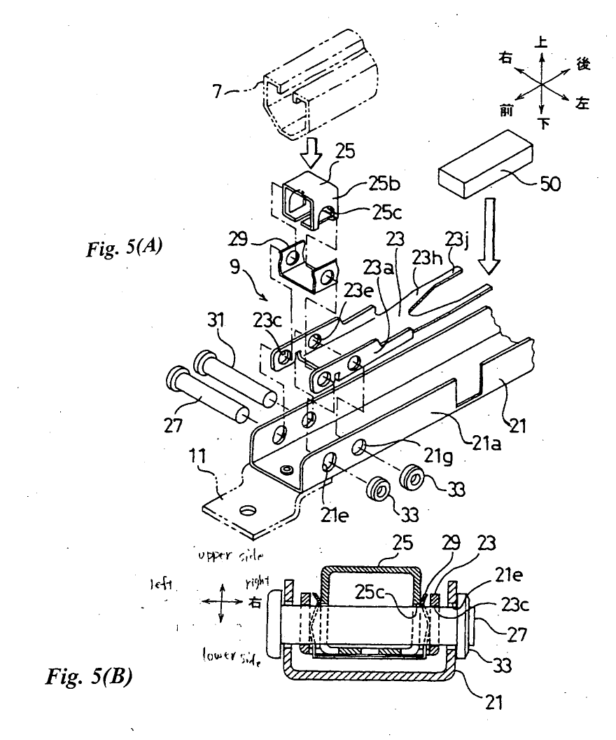

The other operational and advantageous features of the seat weight measuring device 9 of the present invention may be the same as those of the above-described seat weight measuring device, shown in FIGS. 5 and 6.

A seat weight measuring device of the present invention can be suitably applied to a seat weight measuring device for a vehicle, installed below a vehicle seat, for measuring a seat load including the load of an occupant sitting on the vehicle seat.

The priority applications, Japanese Patent Application No. 2003-184649, filed on Jun. 27, 2003 and Japanese Patent Application No. 2004-15710, filed on Jan. 23, 2004 are both incorporated herein by reference in its entireties.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A device for measuring a weight of a seat, including the weight of an occupant sitting on the seat, the device comprising:
a resilient member supported by at least one support point;
a load sensor supported by a sensor support and in communication with the resilient member and positioned to receive the weight of the seat;
wherein the device is configured so that the weight of the seat is applied between the at least one support point and the sensor point.

2. The device of claim 1, wherein the resilient member is single acting part.

3. The device of claim 1, wherein the resilient member has two acting parts.

4. The device of claim 1 further comprising a pin bracket in communication with the seat and the resilient member.

5. The device of claim 4, wherein the pin bracket of the present invention is rotatably supported by a base pin.

6. The device of claim 5, wherein the pin bracket transmits the seat weight to the bracket pin.

7. A device for measuring seat weight including the weight of an occupant sitting on the seat, the device comprising:
a base having two side plates;
an arm rotatably supported by and interdisposed between the side plates of the base via a base pin;
a pin bracket in communication with the arm via a bracket pin and further in communication with the seat;
a load sensor in communication with the arm; and wherein the pin bracket is located between the base pin and the load sensor.

8. The device of claim 7, wherein the arm comprises a single acting part.

9. The device of claim 7, wherein the arm comprises two acting parts.

10. The device of claim 7, wherein the pin bracket of the present invention is rotatably supported by the base pin.

11. The device of claim 10, wherein the pin bracket transmits the seat weight to the bracket pin.

12. The device of claim 7, wherein the arm comprises two arm sideplates.

13. The device of claim 12 further comprising a spring leaf interdisposed between the two arm side plates
